(19) United States
(12) Patent Application Publication
(10) Pub. No.: US 2007/0137455 A1
(43) Pub. Date: Jun. 21, 2007

(54) Conduit hack saw

(76) Inventor: Charles W. Watkins, Columbia, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(21) Appl. No.: 11/311,743

(22) Filed: Dec. 19, 2005

(51) Int. Cl. B23D 49/10; B27B 11/10

(52) U.S. Cl. 83/743; 30/372; 30/519

(57) ABSTRACT

A hand-held conduit-cutting device is disclosed. The device uses a battery powered, motor driven reciprocating saw blade to cut electrical conduit and other tubing. The apparatus can be angled to a variety of positions to make positioning the conduit-cutting device easier for cutting the conduit or other tubing.

### BACKGROUND OF THE INVENTION

1. Field of the Invention

This invention generally relates to the field of tube cutting devices and, in particular, to a hand-held, battery-operated tool for cutting tubing and electrical conduit.

2. Background of the Prior Art

Electricians and plumbers must cut tubing to provide lengths suitable for use in installing electrical conduits and plumbing systems. While there have been powered cutters for many years, commercially available machines can hardly be considered to be portable. Proposals for hand held tools have had shortcomings that presumably resulted in a lack of commercialization.

Conduit cutting can be quite difficult and awkward, especially if the cutting must be performed at the job site, and the location of the operation is quite confined. Often, the person making the cut must hold some other item, such as an element covering the conduit being cut, or the like while the cutting operation is being carried out. In such an instance, the cutting operation may require two people, which can be wasteful.

In many instances, the conduit or tubing may be in the ceiling requiring the operator to lift the cutting tool over the operator's head throughout the duration of the procedure.

While the art has many tube cutters, and even has several examples of hand-held tube cutters, none of the devices presently known in the art is capable of performing cutting operations at a variety of angles while being held in a user's hand, and while further permitting the user to have his other hand free.

Therefore, there is a need for a conduit-cutting device that can be operated by a single user with one hand and that can also perform other operations associated with a conduit cutting operation.

### SUMMARY OF THE INVENTION

It is, therefore, an object of the present invention to provide a conduit-cutting device that avoids the disadvantages of the prior art.

It is a main object of the present invention to provide a conduit-cutting device that can be operated by a single user with one hand.

It is another object of the present invention to provide a motorized conduit-cutting device that can be adjusted to a variety of angles. A related object is to provide a conduit-cutting device having a variable speed motor. A further related object is to provide a conduit-cutting device that is portable.

The present invention relates to a portable conduit-cutting device for cutting conduit that comprises tubing made of metal or other semi-rigid material. While various sizes of such tubing may be cut, the embodiment described herein is designed to cut conduit having a diameter of from ¼ inch to 1 inch. The portable conduit-cutting device of the present invention may be powered by a battery mounted in a housing comprising part of the assembly.

An important object of the present invention is to provide a conduit-cutting device that is sufficiently automatic that an operator can cut off sections of conduit using only one hand to operate the device, allowing a second hand for holding or positioning the conduit as necessary. The portable conduit-cutting device of the present invention can be preliminarily set by an operator for a cutting operation, and thereafter the operator can hold the device and operate it using only one hand.

In accordance with the above objects, a conduit-cutting device is disclosed. The device uses a battery powered, motor driven reciprocating saw blade to cut electrical conduit and other tubing. The apparatus can be angled to a variety of positions to make positioning the conduit-cutting device easier for cutting the conduit or other tubing.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 shows a side elevational view of a conduit cutting apparatus according to one embodiment of the present invention.

FIG. 2 shows a top plan view of a conduit cutting apparatus according to one embodiment of the present invention.

### DETAILED DESCRIPTION OF THE INVENTION

The invention summarized above and defined by the enumerated claims may be better understood by referring to the following description, which should be read in conjunction with the accompanying drawings in which like reference numbers are used for like parts. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

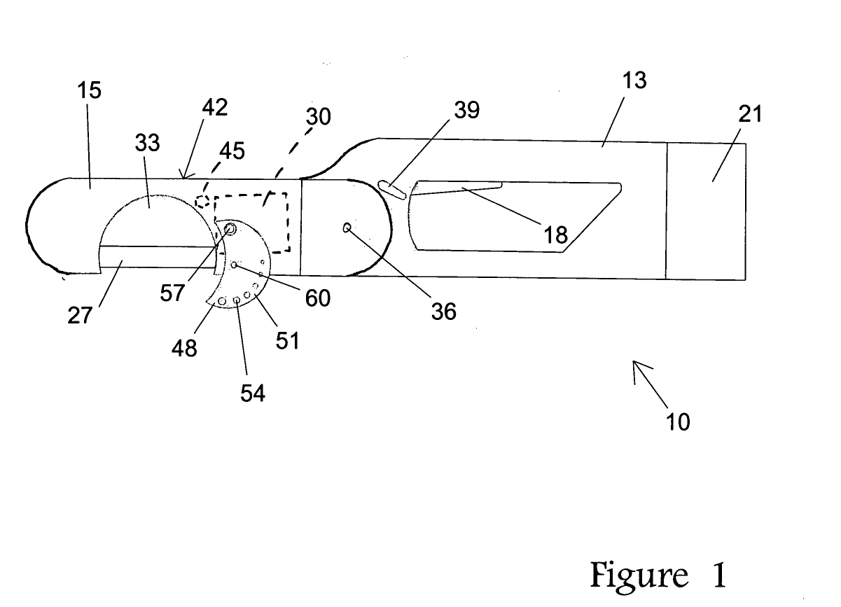

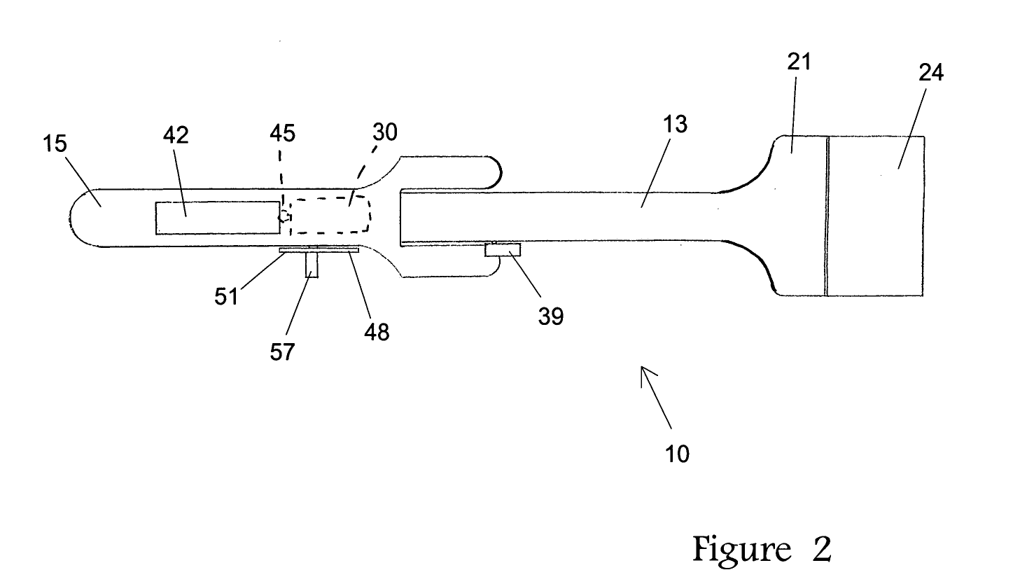

Referring to the drawings, FIGS. 1 and 2 show a conduit-cutting device, indicated generally as 10, according to the present invention. The cutting device 10 comprises a handle portion 13 and a pivotable cutting portion 15. The handle portion 13 includes a trigger switch 18 and a housing 21 for a battery 24. The cutting portion 15 includes a blade 27 operationally connected to a reciprocating motor 30, and an opening 33 that enables a piece of conduit tubing to be urged into the opening 33 while cutting.

In some embodiments, the motor 30 enables variable speed operation of the blade 27. The motor 30 is powered by battery 24 through trigger switch 18 that controls power to the motor 30. The battery 24 is connected to the motor 30 through the switch 18. In a preferred embodiment, the battery 24 is a Lithium polymer rechargeable battery or a Nickel-Cadmium rechargeable battery. Other types of batteries can be used. A charging port for the battery 24 may also be provided.

The cutting portion 15 is pivotably connected to the handle portion 13 by means of a hinge 36 so that the cutting portion 15 can be conveniently adjusted to enable cutting of conduit at any desired position. A release lever 39 on the handle portion 13 operationally engages the cutting portion to lock or release the pivotable cutting portion 15 from its in-line position. In a preferred embodiment, the release lever 39 enables the cutting portion to be locked in any desired angled position from 0° to 90°.

To ensure complete cutting of a conduit, a viewing window 42 may be provided in the cutting portion 15. An operator can view the conduit through the viewing window 42 to see that the blade 27 has penetrated completely through the conduit. In some embodiments, a light 45 may be included to illuminate the viewing window. The light 45 should also be powered by the battery 24 and operate simultaneously with operation of the blade 27. In some embodiments, the light 45 can operate independently of the blade operation.

An accessory bolt-cutting device 48 may also be provided. The bolt cutting device 48 comprises a substantially crescent-shaped holding plate 51 pivotally attached to the cutting portion 15. The holding plate 51 includes a plurality of apertures 54 sized and configured to enable bolts of varying sizes to be engaged by at least one of the apertures 54. In a preferred embodiment, the apertures 54 may be internally threaded to hold a bolt in place. A pin 57 is provided on the holding plate 51 to enable an operator to rotate the plate about hinge 60, so the blade 27 can engage the bolt for cutting. In use, an operator places a bolt in an appropriate aperture 54 and rotates the holding plate until the bolt engages the blade 27. The motor is started to begin operation of the blade 27 and the operator continues to urge the bolt against the blade 27 to cut through the bolt. In a preferred embodiment, the holding plate 51 may be biased to return to the disengaged position by a spring or other means.

The invention has been described with references to preferred embodiments. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A portable conduit cutting apparatus, comprising:
a handle portion;
a cutting portion having a blade, wherein said cutting portion is pivotally attached to said handle portion, said cutting portion further comprising an opening to enable a conduit being cut to enter therein; and
a motor operationally connected to said blade.

2. The conduit cutting apparatus according to claim 1, wherein said motor comprises a reciprocating motor.

3. The conduit cutting apparatus according to claim 1, wherein said motor comprises a variable speed motor.

4. The conduit cutting apparatus according to claim 1, wherein said motor is an electric motor, said apparatus further comprising a battery.

5. The conduit cutting apparatus according to claim 4, further comprising a switch for selectively supplying electrical energy from said battery to said motor.

6. The conduit cutting apparatus according to claim 1, said handle portion further comprising a release lever that operationally engages said cutting portion to lock or release said cutting portion from an in-line position.

7. The conduit cutting apparatus according to claim 6, wherein said release lever enables said cutting portion to be locked in an angled position from 0° to 90°.

8. The conduit cutting apparatus according to claim 1, said cutting portion further comprising a viewing window.

9. The conduit cutting apparatus according to claim 1, said cutting portion further comprising a light.

10. The conduit cutting apparatus according to claim 9, wherein said light is battery powered.

11. The conduit cutting apparatus according to claim 10, further comprising a switch for selectively supplying electrical energy from said battery to said light.

12. The conduit cutting apparatus according to claim 9, wherein said light operates simultaneously with said motor.

13. The conduit cutting apparatus according to claim 1, further comprising a bolt-cutting device.

14. The conduit cutting apparatus according to claim 13, said bolt-cutting device further comprising a holding plate pivotally attached to said cutting portion, said holding plate comprising a plurality of apertures sized and configured to enable bolts of varying sizes to be engaged by at least one of said apertures.

15. The conduit cutting apparatus according to claim 14, said plurality of apertures being internally threaded to engage said bolt.

16. The conduit cutting apparatus according to claim 14, wherein said plate can be rotated to engage a bolt against said blade.

17. The conduit cutting apparatus according to claim 14, wherein said plate is biased to return to a disengaged position.
